(19) United States
(12) Patent Application Publication
(10) Pub. No.: US 2011/0100075 A1
(43) Pub. Date: May 5, 2011

(54) KEY INTERLOCK DEVICE FOR VEHICLE

(75) Inventors: Young-Bum CHO, Hwasung-shi (KR); Jin-Sang Chung, Soowon-shi (KR)

(73) Assignees: Hyundai Motor Company, Seoul (KR); Kia Motors Corporation, Seoul (KR)

(21) Appl. No.: 12/795,545

(22) Filed: Jun. 7, 2010

(30) Foreign Application Priority Data
Oct. 30, 2009 (KR) 10-2009-0103905

(51) Int. Cl. B60R 25/00; E05B 65/12; E05B 47/00

(52) U.S. Cl. 70/183

(57) ABSTRACT

A key interlock device for a vehicle may include camshaft including a locking plate, wherein the locking plate has a first curved portion and a second curved portion to form an inter-wall therebetween, a solenoid including a lock bar disposed above the locking plate, and a controller that detects whether the shift lever is at the PARK position and the position of the key and controls the lock bar to be coupled to or decoupled from the locking plate in accordance with the detected result, wherein the lock bar is coupled to the first curved portion while the key is at the LOCK position, and is disposed above the second curved portion when the key is at the ON position, and wherein the lock bar prevents the key from turning from the ON position to the ACC position while the lock bar is coupled to the second curved portion.

### CROSS-REFERENCE TO RELATED APPLICATION

The present application claims priority to Korean Patent Application No. 10-2000-0103905, filed on Oct. 30, 2009, the entire contents of which is incorporated herein for all purposes by this reference.

### BACKGROUND OF THE INVENTION

1. Field of the Invention

The present invention relates to a key interlock device for a vehicle which allows a key to be pulled out only when the shift lever of vehicles equipped with an automatic transmission is in the ‘park position’ P, in more detail, a key interlock device that physically prevents a camshaft from rotating.

2. Description of Related Art

Key interlock devices of vehicles with an automatic transmission prevent vehicles from unexpectedly starting and parked vehicles from moving, by allowing the vehicle to start only when the shift lever is at the P position and allowing the key from being pulled out only when the shift lever is at the P position and the key is at the LOCK position. These devices are applied to vehicles used in America, Australia, England, etc.

Key interlock devices in the related art was designed to be operated by an ATM (Automatic Transmission) control unit.

That is, the device controlling the transmission of a vehicle is provided with the key interlock function and controls the turn of the key in accordance with the position of the shift lever. However, there was a problem that it requires an additional electrical connection, such that the electric load increases in the device.

Further, there was a problem that since a solenoid controlling the turn of a key set operates when the shift lever is moved from the P (parking) position to the R (rearward) position, this configuration makes a noise when the shift lever is moved. Further, there was a problem that due to continuously applying the battery's voltage, the solenoid may become overheated, for characteristics of the push type solenoid (a lock bar inserted at a predetermined depth in the solenoid is protruded by an electric signal).

For reference, a key set of general vehicles, as shown in FIG. 1, is formed by assembling a cylinder assembly 110 equipped with a key cylinder 130 determining whether the inserted key is authorized and rotating with the key, and a body assembly 100 equipped with a camshaft 120 combined with the key cylinder 130 and operates an ignition switch 140 in accordance with the rotation of the key cylinder 130.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a key interlock device that ensures stability by reducing factors causing load in an ATM, and prevents overheat by changing a push type solenoid of the related art into a pull type solenoid (in which a lock bar protruding from the solenoid is moved back inside the solenoid by an electric signal).

In an aspect of the present invention, the key interlock device for a vehicle that allows a key to be inserted in a key cylinder and turned to LOCK, ACC, ON, and START positions and to be pulled out when a shift lever is at a PARK position, may include a camshaft including a locking plate, wherein the locking plate has a first curved portion formed along a rim of the locking plate and a second curved portion formed along the rim of the locking plate at a predetermined distance from the first curved portion to form an inter-wall therebetween, a solenoid including a lock bar disposed above the locking plate, and a controller that detects whether the shift lever is at the PARK position and the position of the key and controls the lock bar to be coupled to or decoupled from the locking plate by selectively supplying the power to the solenoid in accordance with the detected result, wherein the lock bar is coupled to the first curved portion while the key is at the LOCK position, and is disposed above the second curved portion when the key is at the ON position, and wherein the lock bar prevents the key from turning from the ON position to the ACC position while the lock bar is coupled to the second curved portion.

An inclined surface may be formed at a lower end of the lock bar such that the lock bar slides along the first curved portion, while the key is turned in the LOCK position.

A first slide surface of the first curved portion may include an inclination larger than an inclination of a second slide surface thereof and a first slide surface of the second curved portion includes an inclination larger than an inclination of a second slide surface thereof, and wherein the second slide surface of the first curved portion is adjacent to the first slide surface of the second curved portion, wherein the first curved portion is formed to be cut around the rim of the locking plate with a predetermined length, and wherein the second curved portion is formed to be cut at a front portion of the locking plate in a predetermined depth around the rim of the locking plate with a predetermined length to form a slide bottom at a rear portion of the locking plate.

The lock bar may slide above the second curved portion while the key is turned to the START position, and the lock bar slides along the slide bottom of the locking plate to the first curved portion while the key is turned from the ON position to the LOCK position, wherein the lock bar is coupled to the second curved portion in a predetermined time period after the key turns to the START position to prevent the key from turning from the ON position to the ACC position, and wherein when the key cylinder and the camshaft are simultaneously pressed and rotated from the ON position to the LOCK position, the lock bar reaches the LOCK position across the inter-wall along the slide bottom.

In another aspect of the present invention, the lock bar may be decoupled from the locking plate when the key is at the ACC position or starts to turn from the ON position to the ACC position, wherein the lock bar is positioned on the inter-wall of the locking plate while the key is at the ACC position.

In further another aspect of the present invention, the lock bar may move up when the power is supplied to the solenoid and moves down when the power is cut, and the controller supplies the power to the solenoid when the shift lever is in the PARK position and when the key is at the ACC position or starts to turn from the ON position to the ACC position, wherein the power that is supplied to the solenoid is cut when a predetermined time period has passed after the power is supplied.

The lock bar may be coupled to the second curved portion in a predetermined time period after the key turns to the START position to prevent the key from turning from the ON position to the ACC position.

According to the present invention having the above configuration, since the camshaft cannot physically rotate when the key is at the ON position and can rotates only when power is supplied to the solenoid, it is possible to reduce electric load.

Further, since the inclined surface is formed at the lower end of the lock bar and can slide in one direction in the first curved portion and the second curved portion, it is possible to minimize the operational time of the solenoid. Therefore, it is possible to reduce noise and electric load by the operation of the solenoid.

Further, as compared with the configurations of the related art in which the solenoid operates when the shift lever is moved, in the present invention, since the solenoid operates when the key is turned, the number of operation times of the solenoid is reduced. Furthermore, since the operational sound of the solenoid is made simultaneously with start of the engine, passengers cannot recognize the operational sound of the solenoid.

In addition, since a pull type solenoid is used and power supplied to the solenoid is cut after predetermined time has passed, it is possible to prevent overheat and pull out the key even in an emergency, such as when the power supplied to the solenoid is cut.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view showing positions of a key cylinder, a camshaft, and an ignition switch in a key set of the related art.

FIG. 2 is a perspective view showing when a camshaft and a solenoid are combined, according to an exemplary embodiment of the present invention.

FIG. 3 is an operational view sequentially illustrating the operation of the camshaft and a lock bar in accordance with positions of a key, according to an exemplary embodiment of the present invention.

FIG. 4 is an operational view illustrating that the camshaft is rotatable when the solenoid operates, and the camshaft is not rotatable when the solenoid does not operate.

FIG. 5 is a flowchart illustrating the logic of a controller according to an exemplary embodiment of the present invention.

FIGS. 6 and 7 are a perspective view and an operational view illustrating that the key is turned to the LOCK position when the solenoid does not operate.

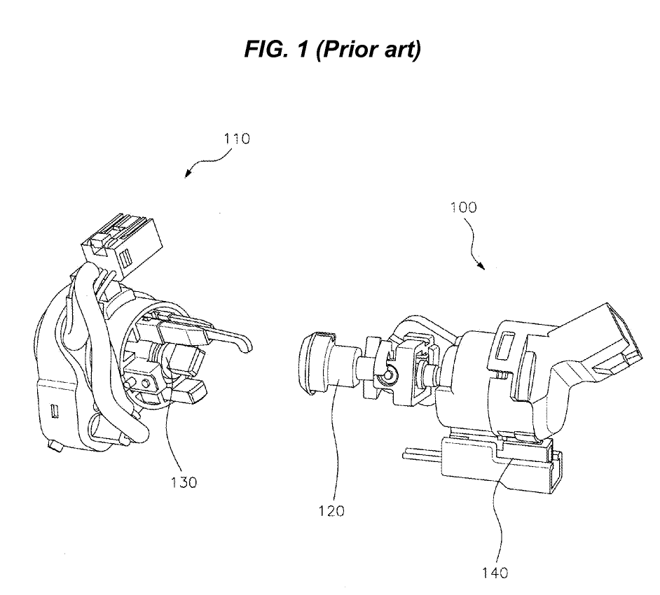

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A key interlock device for a vehicle according to exemplary embodiments of the present invention is described hereafter in more detail with the accompanying drawings.

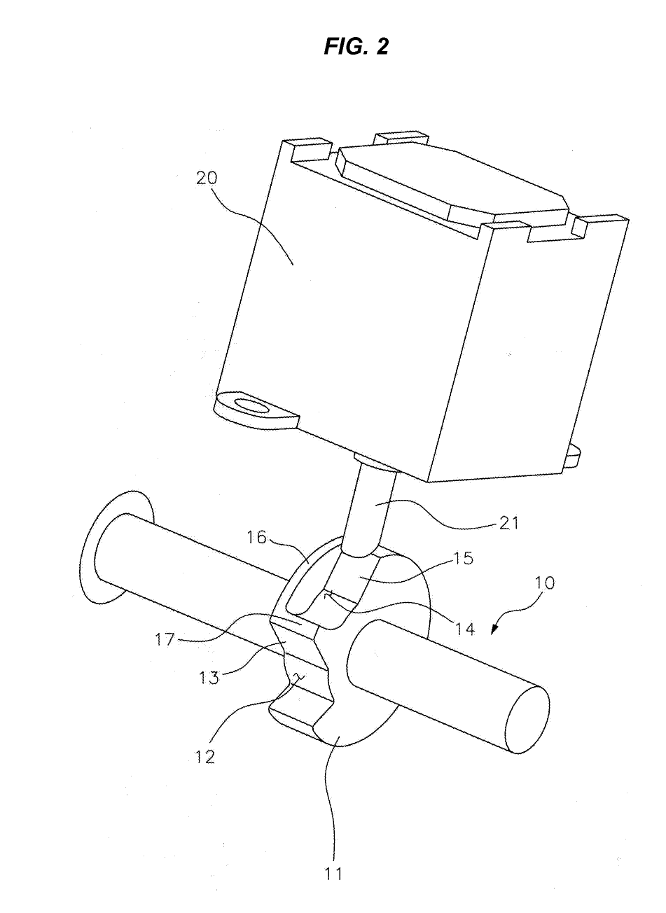

Referring to FIG. 2, a key interlock device, in an exemplary embodiment of the present invention, has a structure in which a circular locking plate 11 increases in diameter at a predetermined position of a camshaft 10. That is, the camshaft 10, as shown in the figure, is fitted through the center of the locking plate 11. A first curved portion 12 cut at a predetermined depth is formed at a predetermined position around the rim of the locking plate 11. Further, a second curved portion 14 cut at a predetermined depth is formed at a predetermined distance from the first curved portion 12 around the rim. However, as shown in the figure, the first curved portion 12 is formed such that both sides of the locking plate 11 are symmetric, whereas the second curved portion 14 is formed by cutting only the front of the locking plate 11 at a predetermined depth. Accordingly, a slide bottom 16 is formed at the rear portion of the second curved portion 14 to cover the cut portion.

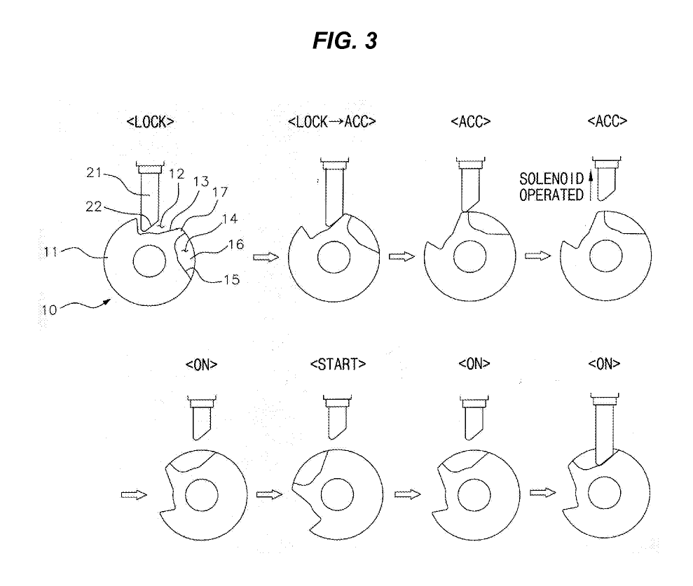

As shown in FIG. 3 showing the key interlock device of FIG. 2 seen from the front, the first curved portion 12 has a first slide surface 13 of which one side (at the left from a lock bar in the lock position) has a large inclination and the other side (at the right from the lock bar in the lock position) has small inclination. Further, since the second curved portion 14 is spaced at a distance apart from the first curved portion 12, inter-wall 17 is formed between the first curved portion 12 and the second curved portion 14. The second curved portion 14 also has a second slide surface 15 of which one side (adjacent to the inter-wall) has large inclination and the other side has small inclination.

A solenoid 20 having the built-in lock bar 21 is disposed above the camshaft 10. The lock bar 21 moves up/down along the curved surfaces of the first curved portion 12 and the second curved portion 14 of the locking plate 11 and the solenoid 20 is equipped with the lock bar 21 in a pull type. That is, the lock bar 21 maximally protrudes outside the solenoid 20, when pressing force is applied inside the solenoid 20, elastic force is generated against the pressing force, such that the lock bar 21 is inserted by a predetermined depth into the solenoid while the solenoid 20 is operated. Therefore, the solenoid 20 keeps the lock bar 21 down when power is not supplied and moves up the lock bar 21 (inserts the lock bar into the solenoid by a predetermined depth) when power is supplied.

As described above, the solenoid 20 is disposed vertically above such that the lock bar 21 is aligned with the center of the locking plate 11, while it is disposed such that the lock bar 21 is maintained down on the first curved portion 12 at the LOCK position in which the key can be inserted and pulled out. Similarly, as shown in FIG. 3, the first curved portion 12 and the second curved portion 14 each have predetermined width and length such that the lock bar 21 is positioned on the first curved portion 12 when the key is at the LOCK position, on the inter-wall 17 when the key is at the ACC position, above the second curved portion 14 when the key is at the ON position, and disposed to the second curved portion 14 in a predetermined time after the key is at the START position.

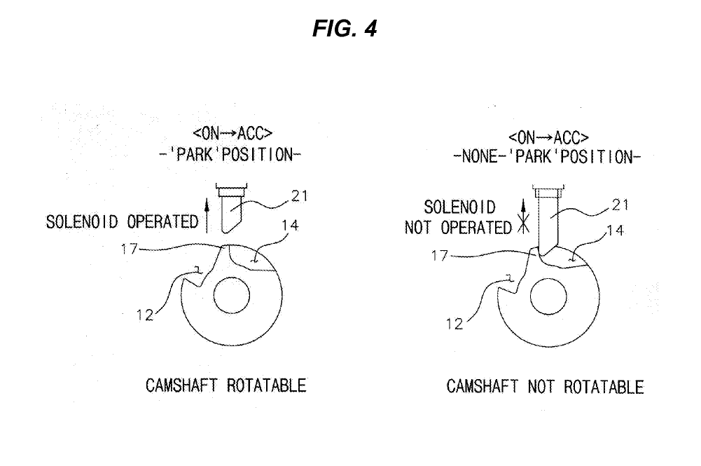

Therefore, in an exemplary embodiment of the present invention, the locking plate 11 and the solenoid 20 disposed as described above prevent the camshaft 10 from rotating, when the key is at the ON position after the key is turned to the START position and the solenoid 20 does not operate (the lock bar does not move up), as shown in FIG. 4.

On the other hand, a controller, in an exemplary embodiment of the present invention detects the position of the key turned, in accordance with the connection state of a terminal on an ignition switch (whether B1 and B2, which are described below, are turned on or off) while communicating with a key set, detects the position of a shift lever while communicating with a transmission or a transmission control unit, and allows or cuts the power that is supplied to the solenoid 20.

The operation of a key interlock device according to exemplary embodiments of the present invention is described hereafter in more detail with the accompanying drawings.

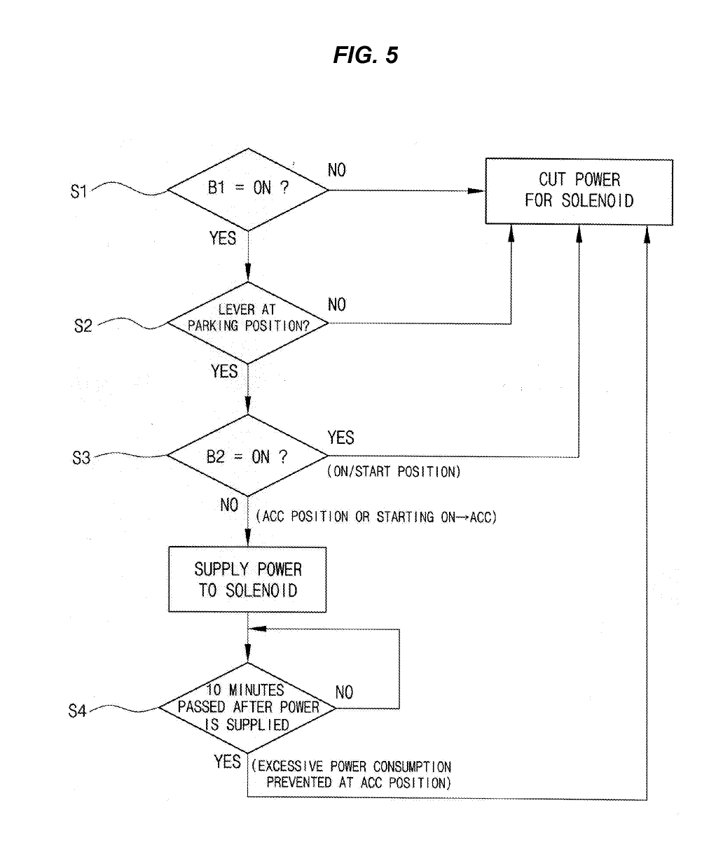

The controller of the present invention operates in accordance with the logic shown in FIG. 5. In FIG. 5, B1, which is a terminal in the ignition switch, is turned on when the key is at the ACC, ON, or START position, and turned off only when the key is at the LOCK position. Further, B2, which is a terminal in the ignition switch, is turned on when the key is at the ON position, and turned off when the key is at the LOCK or ACC position. However, the B2 is turned off when the key starts to turn to the ACC position even though the key is at the ON position.

Therefore, the controller operates in accordance with the following steps. First, the controller detects whether B1 terminal is turned on/off (S1), detects whether the shift lever is at the parking position P (S2), detects whether B2 terminal is turned on/off (S3), and then determines to supply power to the solenoid. Further, after power is supplied to the solenoid in accordance with the steps, the controller detects whether 10 minutes has passed after power is supplied, and then cuts the power when 10 minutes has passed (S4).

That is, the controller determines that the key is not at the LOCK position where it is removable in step S1, determines whether the shift lever is at the parking position in step S2 when the value of step S1 is true, and determines that the key is at the ACC position or starts to be turned from the ON position to the ACC position in step S3 when the value of S2 is true. The controller supplies power to the solenoid 20 through the steps, and cuts the power when 10 minutes has passed after the power is supplied, in order to prevent electric overload of the solenoid.

Power supply of the controller and the operation of the solenoid at the positions of the key are illustrated in detail in FIG. 3.

As shown in FIG. 3, when the key is at the LOCK position, the lock bar 21 has moved down in the first curved portion 12 of the locking plate 11 from the solenoid 20. As the key is turned from the LOCK position to the ACC position, the key cylinder and the camshaft 10 are rotated by the rotation of the key and the lock bar 21 moves to the inter-wall 17, with the inclined surface 22 at the lower end sliding along the first slide surface 13. In this operation, as the ignition switch is operated by the rotation of the camshaft 10, the on/off state of B1 and B2 changes and the controller receives ‘yes’ in step S1 and ‘no’ in step S3. Accordingly, when the shift lever is at the park position, the solenoid 20 operates and lock bar 21 on the inter-wall 17 moves up above the locking plate 11. The key can be freely turned to the START position when the lock bar 21 has moved up, and returns from the START position to the ON position when the engine starts. Further, when it is determined that 10 minutes has passed in step S4, the power supplied to the solenoid 20 is cut and the lock bar 21 moves down into the second curved portion 14.

On the other hand, the present invention may be configured such that the controller cuts the power supplied to the solenoid because ‘yes’ is outputted in step S4 when the key starts to be turned from the ACC position to the ON position. However, 10 minutes is given due to preventing the lock bar 21 from being obstructed by friction at the inclined surface 22 at the lower end of the lock bar 21 when the key returns from the START position to the ON position, even though the lock bar 21 moved down in the second curved portion 14 can slide on the second slide surface 15 to the START position.

The lock bar 21 that has moved down in the second curved portion 14 prevents the camshaft 10 from rotating, as shown in FIG. 4, unless the solenoid 20 operates in accordance with the logic shown in FIG. 5.

However, it is impossible to pull out the key when power cannot be supplied to the solenoid 20 due to discharge of a battery.

However, the key interlock device of the present invention makes it possible to pull out the key even in an emergency as described above.

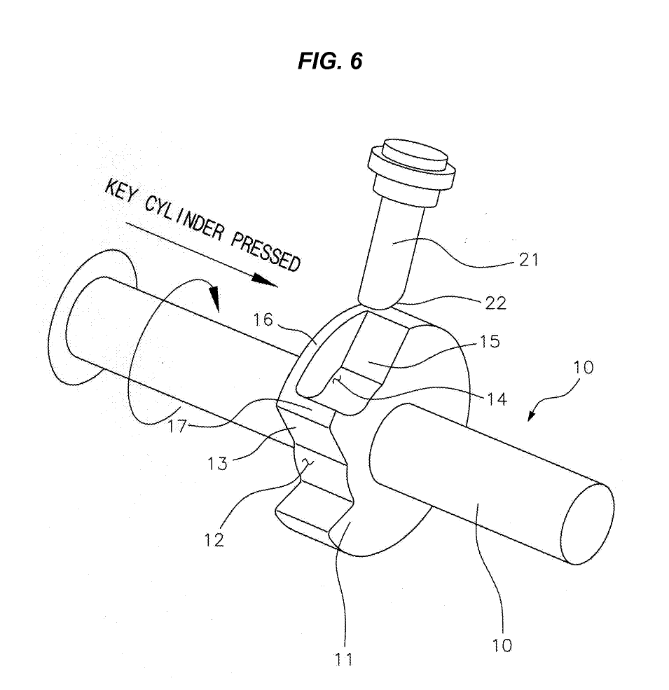

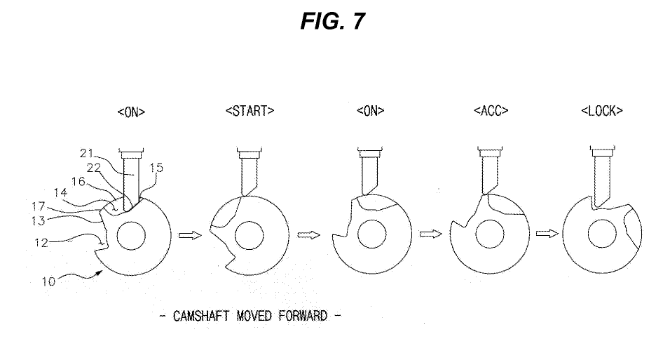

As shown in FIGS. 6 and 7, after the key is turned from the START position to the ON position, the lock bar 21 engaged with the second curved portion 14 comes out of the second curved portion 14 along the second slide surface 15. Thereafter while the key is pressed and turned to the LOCK position, the key cylinder and the camshaft 10 are simultaneously pressed in the direction of an arrow shown in FIG. 6 and rotated, and the lock bar 21 can reach the LOCK position across the inter-wall 17 along the slide bottom 16.

For convenience in explanation and accurate definition in the appended claims, the terms “upper”, “lower”, “front”, “rear” and “bottom” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the claims appended hereto and their equivalents.

What is claimed is:

1. A key interlock device for a vehicle that allows a key to be inserted in a key cylinder and turned to LOCK, ACC, ON, and START positions and to be pulled out when a shift lever is at a PARK position, the key interlock device comprising:
a camshaft including a locking plate, wherein the locking plate has a first curved portion formed along a rim of the locking plate and a second curved portion formed along the rim of the locking plate at a predetermined distance from the first curved portion to form an inter-wall therebetween;
a solenoid including a lock bar disposed above the locking plate; and
a controller that detects whether the shift lever is at the PARK position and the position of the key and controls the lock bar to be coupled to or decoupled from the locking plate by selectively supplying the power to the solenoid in accordance with the detected result,
wherein the lock bar is coupled to the first curved portion while the key is at the LOCK position, and is disposed above the second curved portion when the key is at the ON position, and
wherein the lock bar prevents the key from turning from the ON position to the ACC position while the lock bar is coupled to the second curved portion.

2. The key interlock device for the vehicle according to claim 1, wherein an inclined surface is formed at a lower end of the lock bar such that the lock bar slides along the first curved portion, while the key is turned in the LOCK position.

3. The key interlock device according to claim 1, wherein a first slide surface of the first curved portion includes an inclination larger than an inclination of a second slide surface thereof and a first slide surface of the second curved portion includes an inclination larger than an inclination of a second slide surface thereof, and wherein the second slide surface of the first curved portion is adjacent to the first slide surface of the second curved portion.

4. The key interlock device according to claim 3, wherein the first curved portion is formed to be cut around the rim of the locking plate with a predetermined length.

5. The key interlock device according to claim 3, wherein the second curved portion is formed to be cut at a front portion of the locking plate in a predetermined depth around the rim of the locking plate with a predetermined length to form a slide bottom at a rear portion of the locking plate.

6. The key interlock device for the vehicle according to claim 1, wherein the lock bar slides above the second curved portion while the key is turned to the START position, and the lock bar slides along the slide bottom of the locking plate to the first curved portion while the key is turned from the ON position to the LOCK position.

7. The key interlock device according to claim 6, wherein the lock bar is coupled to the second curved portion in a predetermined time period after the key turns to the START position to prevent the key from turning from the ON position to the ACC position.

8. The key interlock device according to claim 6, wherein when the key cylinder and the camshaft are simultaneously pressed and rotated from the ON position to the LOCK position, the lock bar reaches the LOCK position across the inter-wall along the slide bottom.

9. The key interlock device according to claim 1, wherein the lock bar is decoupled from the locking plate when the key is at the ACC position or starts to turn from the ON position to the ACC position.

10. The key interlock device according to claim 9, wherein the lock bar is positioned on the inter-wall of the locking plate while the key is at the ACC position.

11. The key interlock device according to claim 1, wherein the lock bar moves up when the power is supplied to the solenoid and moves down when the power is cut, and the controller supplies the power to the solenoid when the shift lever is in the PARK position and when the key is at the ACC position or starts to turn from the ON position to the ACC position.

12. The key interlock device for the vehicle according to claim 11, wherein the power that is supplied to the solenoid is cut when a predetermined time period has passed after the power is supplied.

13. The key interlock device according to claim 1, wherein the lock bar is coupled to the second curved portion in a predetermined time period after the key turns to the START position to prevent the key from turning from the ON position to the ACC position.
